(19) United States
(12) Patent Application Publication
(10) Pub. No.: US 2003/0212598 A1
(43) Pub. Date: Nov. 13, 2003

(54) System for managing digital service plans and related promotions

(76) Inventors: Prabhu Raman, Broomfield, CO (US); Abraham Jacob, Denver, CO (US); Karl Denzer, Denver, CO (US); Jamil Modak, Aurora, CO (US); Andy Dixon, Littleton, CO (US)

Correspondence Address: DORR CARSON SLOAN & BIRNEY, PC, 3010 EAST 6TH AVENUE, DENVER, CO, 80206

(21) Appl. No.: 10/430,981

(22) Filed: May 7, 2003

Related U.S. Application Data
(60) Provisional application No. 60/378,458, filed on May 7, 2002.

(51) Int. Cl. G06F 17/60

(52) U.S. Cl. 705/14

(57) ABSTRACT

A database system manages digital service plans and related promotions across a plurality of service providers. The system includes a service provider interface that receives data from service providers and incorporates this data into the service plan/promotion database. A client interface enables clients to retrieve and display data from the service plan/promotion database relating to digital service plans and related promotions that are available for the client's geographic location.

### RELATED APPLICATION

The present invention is based on, and claims priority to the Applicants' U.S. Provisional Patent Application Ser No. 60/378,458, entitled “System For Managing Digital Service Plans And Related Promotions,” filed on May 7, 2002.

### BACKGROUND OF THE INVENTION

1. Field of the Invention

The present invention relates generally to the field of managing digital service plans and related promotions. More specifically, the present invention discloses a database and interface system for gathering data on the availability of various digital service plans and related promotions for potential customers.

2. Statement of the Problem

Consumers are often confronted with a bewildering array of choices in selecting digital services, such as broadband internet data services, digital video, narrowband data services, digital telephony, and others. Some digital services, such as DSL service, are available only in limited geographic areas. Promotional effects for digital services can further complicate matters. Many promotions are offered only for a limited period of time, or only in particular areas, or only by particular local network providers. The financial incentive provided by promotions can also be difficult to compare. Some promotions offer reduced monthly fees for an initial period of time. Other promotions offer discounts on installation or hardware.

This also complicates efforts by retailers, web sites, and others that wish to merchandise and sell digital services to consumers. In order to effectively merchandize digital services, retailers need the ability to determine which digital service plans and promotions are available to their potential customers.

3. Solution to the Problem

The present invention is a centralized, synchronized, and accurate database management system for digital service plans and applicable promotions from across a range of service providers. This information can be automatically updated by service providers over the internet, and can also be made available to clients and potential customers via the internet.

### SUMMARY OF THE INVENTION

The present invention provides a digital service plan and promotional management database and interfaces that collect, normalize and provide access to accurate digital service plan and promotional data from across a range of service providers. The database and interfaces define IDs that enable digital services and promotions to be identified as unique elements, and provide hierarchies that enable service plans to be consolidated from multiple service providers through the use of parent-child relationships. These hierarchies also enable promotional elements to be defined at multiple levels, including geography, service element, and service technology type.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a simplified block diagram of one implementation of the present invention.

FIG. 2 is a simplified block diagram of the tables comprising the service plan/promotion database 20.

FIG. 3 is a diagram of the structure of the provider table 23 in the service plan/promotion database 20.

FIG. 4 is a diagram of the structure of the service table 24 in the service plan/promotion database 20.

FIG. 5 is a diagram of the structure of the promotion table 25 in the service plan/promotion database 20.

FIG. 6 is a diagram of the structure of the cross reference table 26 in the service plan/promotion database 20.

FIG. 7 is a diagram of the structure of the map table 27 in the service plan/promotion database 20.

FIG. 8 is a listing of an XML implementation of the gateway messaging.

FIG. 9 is a workflow diagram of the present invention.

FIG. 10 is a simplified block diagram of digital service plan/promotion database 20 in use within a digital services sales system.

FIG. 11 is an example of a client browser screen showing the results of a serviceability search using the digital service plan/promotion management database 20.

### DETAILED DESCRIPTION OF THE INVENTION

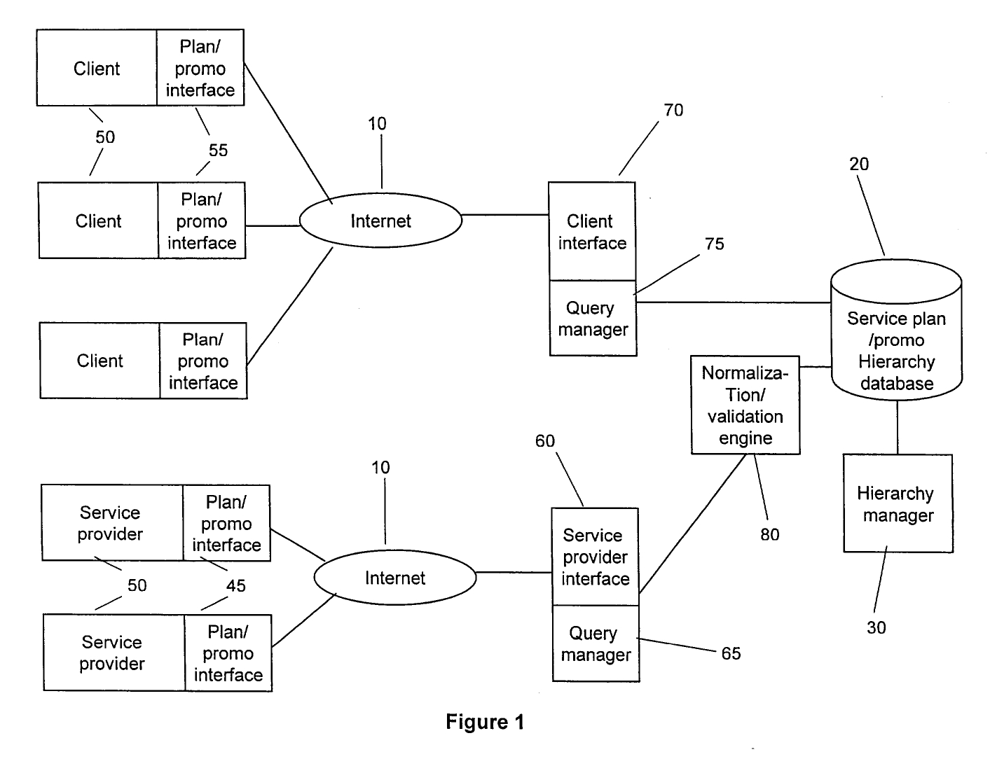

Turning to FIG. 1, a simplified block diagram is shown of one implementation of the present invention. The major components of the system are the service plan/promotion database 20 and the interfaces used to process data from service providers 40 and deliver information to clients 50 (e.g., retailers, computer OEMs, web sites, and others). For example, the invention can operate over the internet 10 and support the needs of companies that need to access accurate, digital service plan and promotional data for merchandising through various portals, including kiosks, web sites, customer service personnel and interactive voice response systems (IVRs).

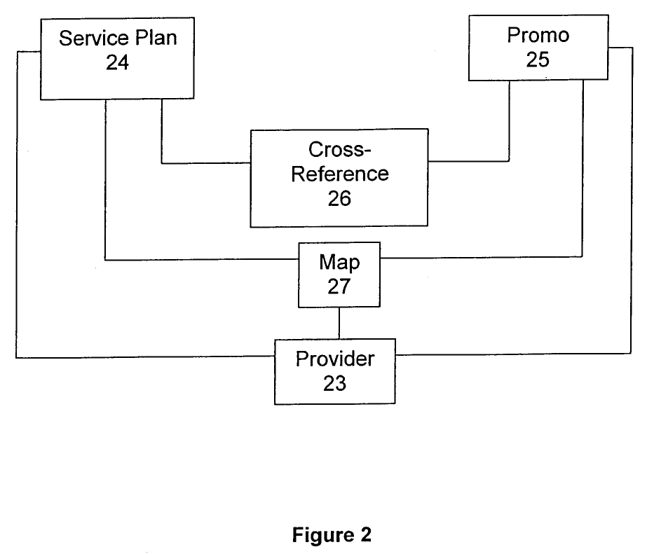

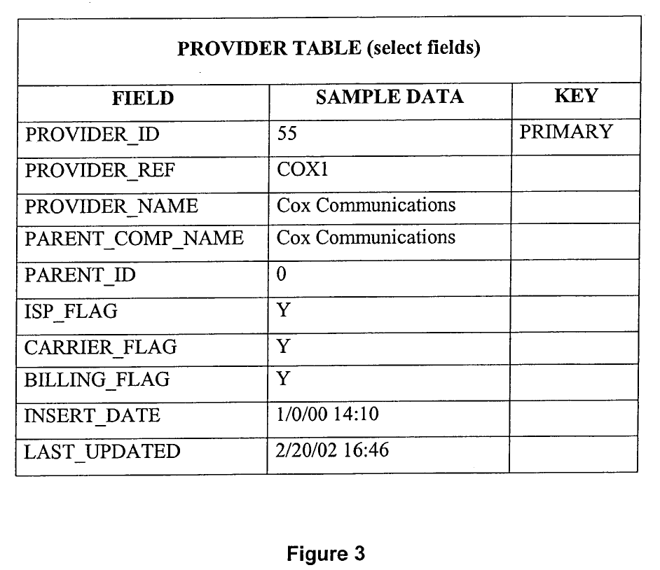

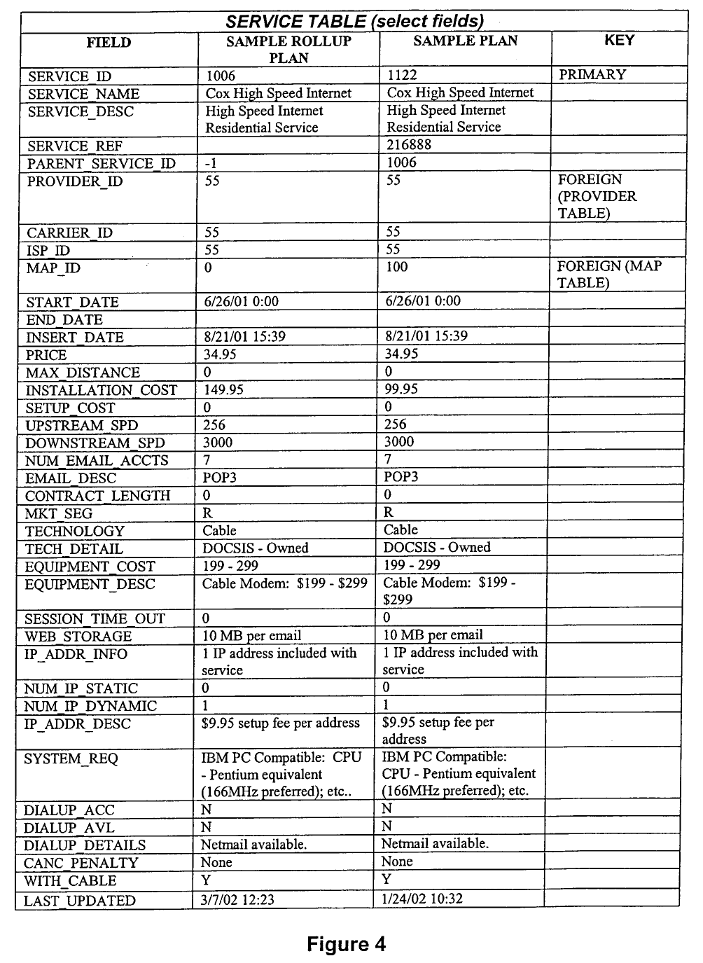

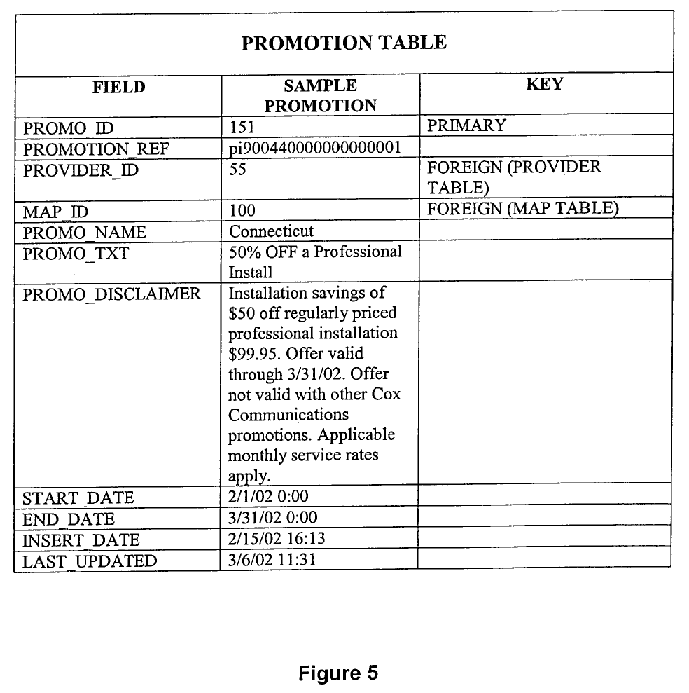

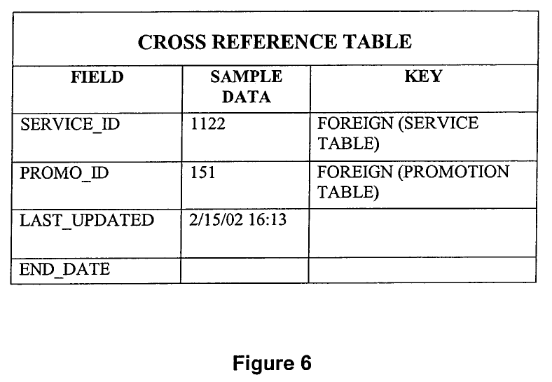

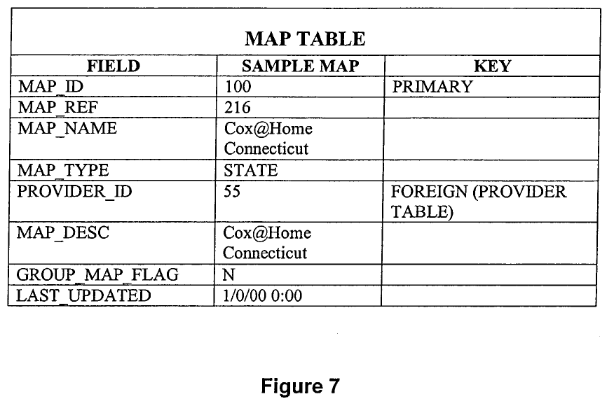

FIG. 2 is a simplified block diagram illustrating the structure of the service plan/promotion database 20. This provides a database of service plans and promotions from across a range of service providers and over a range of geographic locations. FIGS. 3-7 are diagrams of structures of the provider table 23, service table 24, promotions table 25, cross reference table 26, and map table 27, respectively, in the service plan/promotion database 20. These figures catalog the fields that are maintained to describe service plans, providers, and promotions and enable their accurate qualification. The service plan/promotion database 20 is maintained by the hierarchy manager 30 to maintain a consistent hierarchical relationship between providers, digital service plans and promotions. Unique IDs are assigned and used to define and track individual service plans and promotions across network affiliates and service providers. These IDs enable digital services and promotions to be identified as unique elements, and provide hierarchies that enable service plans to be consolidated from multiple providers through the use of parent-child relationships. These hierarchies also enable promotional elements to be defined at multiple levels, including geography, service element, and service technology type. A start date and end date are maintained for each service plan and promotion to enable programmatic communication of data in advance of an effective date, as well as automatic expiration of data based on a termination date. In addition, the database structure shown in FIGS. 3-7 provides the ability to record incremental changes and roll-back changes based on change sets. Changes sets are defined as groups of changes that are tracked based on transaction identifiers assigned to each change.

As shown in FIG. 1, each service provider 40 is equipped with a plan/promotion interface 45 capable of transmitting data over the internet 10 to a service provider interface 60 associated with the service plan/promotion database 20. A query manager 65 can be used to periodically request updated information concerning service plans and promotions from each service provider 40 through these interfaces 45, 60. These interfaces 45, 60 can request and deliver both full and incremental updates for all service plans and promotional elements that are relevant to the service provider 40.

A validation/normalization engine 80 receives data from the service provider interface 60 and applies global and service provider specific business rules to normalize the syntactical format of the data. The validation/normalization engine 80 checks each data element to ensure it conforms with syntactical format. This includes universal formats, as well as formats that are defined by service provider 40. If an error is encountered, a notification is generated. If there are no errors, then the data package is moved into the service plan/promotion database 20. This functionality is used to ensure the service plan and promotional data are both accurate, and that service provider specific differences are eliminated.

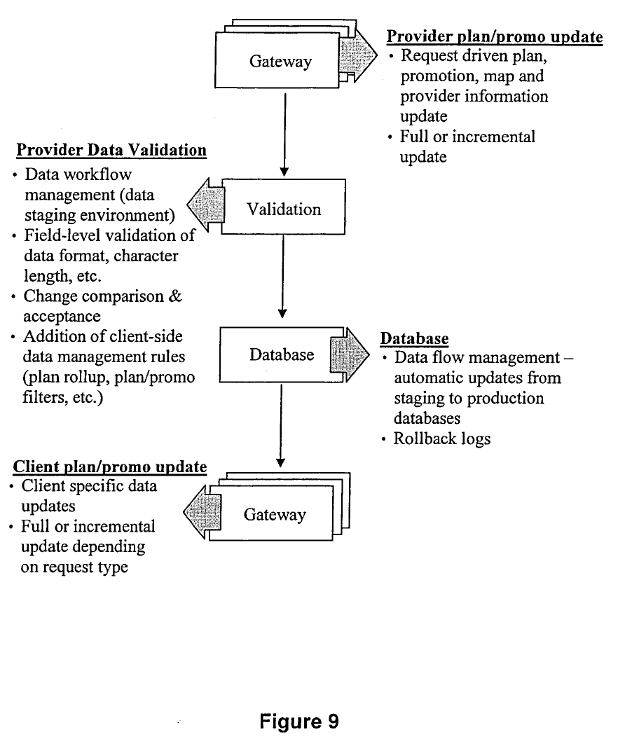

The service plan/promotion database 20 processes queries from clients 50 and delivers data via the internet 10, as illustrated in FIG. 1. Each client 50 is equipped with a plan/promotion interface 55 capable of transmitting data over the internet 10 to a client interface 60 and query manager 65 associated with the service plan/promotion database 20. The client interface 60 receives requests from clients for service plan and promotional data. This request will generate a unique data set that is specific to the client 50 based on the client's geographic location, service requirements and other query parameters, and will manage delivery of data from the service plan/promotion database 20 in the format specified by the client 50. The interfaces 55, 70 can request and deliver both full and incremental updates for all service plans and promotional elements that are relevant to a particular client 50. The work flow for each of the invention components is illustrated in FIG. 9.

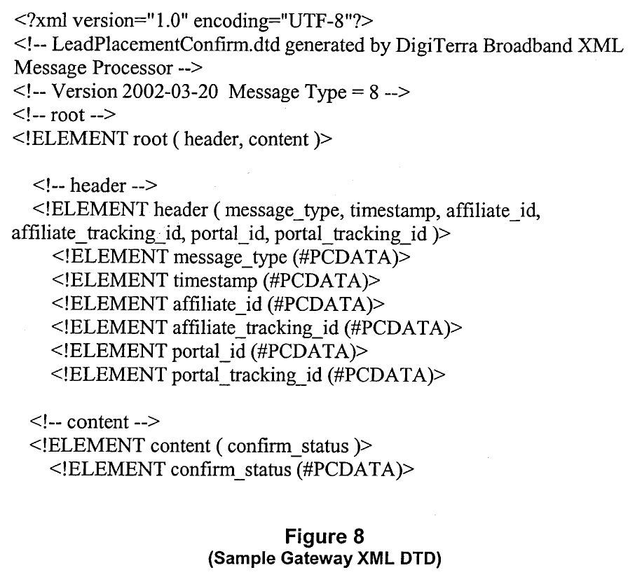

The embodiment of the present invention shown in FIG. 1 employs the internet 10 for data communications between service providers 40 and the service plan/promotion database 20, and between the service plan/promotion database 20 and clients 50. It should be understood that other types of data communications could be readily substituted. For example, direct dial-up connections, dedicated telephone lines, or fiber optic connections could be used for data communications between the service plan/promotion database 20 and the service providers 40 or clients 50. Thus, all types of data communications could be used as “gateways” between the components in the present invention. In the case of an internet-based gateway, any of a variety of standard transport mechanisms (e.g., HTTP, HTTPS, FTP, e-mail) can be used. An example of an XML implementation of the gateway messaging is provided in FIG. 8.

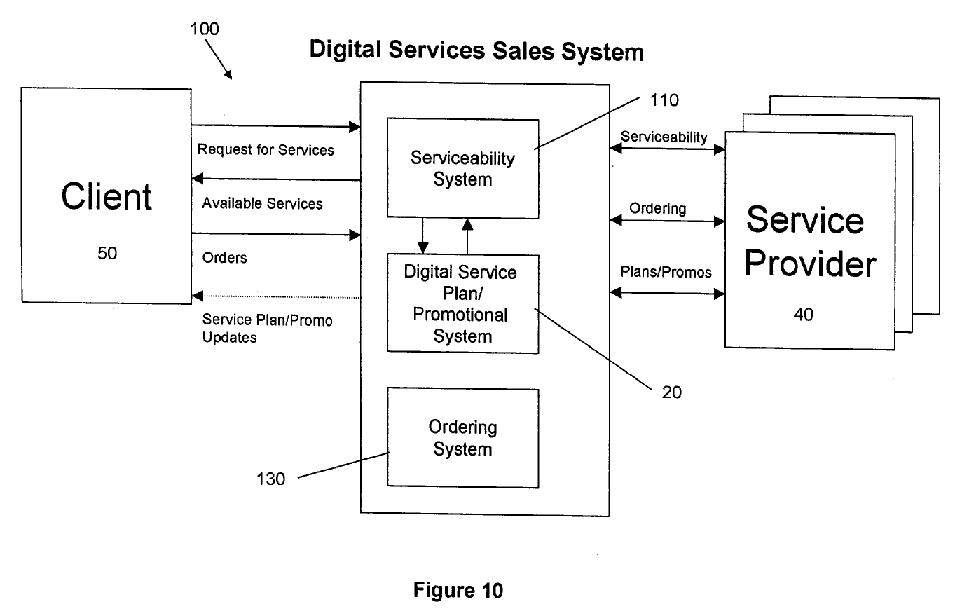

The digital service plan and promotional database 20 is used to support an integrated digital services sales system 100, as shown in FIG. 10. The digital services sales system 100 also includes a serviceability system 110 to determine which service plans are available to a specific potential customer, and an ordering system 130 to process customer orders for digital service plans. This system can be deployed by clients that wish to merchandise and sell digital services. In order to merchandize digital services, clients 50 need the ability to determine which plans and promotions are available to their customers at a specific location, the ability to place orders directly with services providers 40, and the ability to manage these digital services as conventional stock items in a retail setting. It is this functionality that is enabled by the digital service plan and promotional management system.

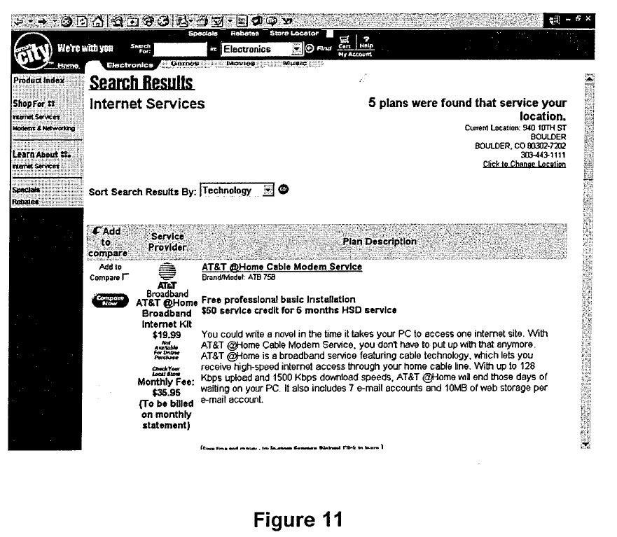

The client interface can include a browser-based interface for clients. FIG. 11 is an example of a client browser screen showing the results of a serviceability search using the digital service plan/promotion management database 20. The potential customer is presented with a list of the available digital service plans for the customer's address. For each available digital service plan, the customer can view a plan description, together with information about the service provider and the price of the plan. The potential customer can also view a side-by-side comparison of the available digital service plans.

The above disclosure sets forth a number of embodiments of the present invention. Other arrangements or embodiments, not precisely set forth, could be practiced under the teachings of the present invention and as set forth in the following claims.

We claim:

1. A system for managing digital service plans and related promotions across a plurality of service providers comprising:
a service plan/promotion database storing information on digital service plans and related promotions that are available over a range of geographic locations;
a service provider interface receiving data from a plurality of service providers regarding digital service plans and related promotions, and incorporating said data into the service plan/promotion database; and
a client interface enabling a client to retrieve and display data from the service plan/promotion database relating to digital service plans and related promotions that are available for the client's geographic location.

2. The system of claim 1 wherein the service plan/promotion database further comprises a provider table storing information on each service provider.

3. The system of claim 1 wherein the service plan/promotion database further comprises a service plan table storing information on each digital service plan.

4. The system of claim 3 wherein the service plan/promotion database further comprises a promotions table storing information on promotions for digital service plans.

5. The system of claim 1 further comprising a hierarchy manager maintaining a consistent hierarchical relationship between providers, digital service plans, and promotions.

6. The system of claim 1 wherein the service provider interface further provides validation and normalization of data received from service providers in a plurality of formats.

7. The system of claim 1 wherein the client interface further comprises a browser-based interface for clients.

8. A method for managing a database of digital service plans and related promotions across a plurality of service providers comprising:
providing a service plan/promotion database storing information on digital service plans and related promotions that are available over a range of geographic locations;
receiving data from a plurality of service providers in a plurality of formats regarding digital service plans and related promotions;
validating and normalizing the data received from service providers;
incorporating the validated and normalized data into the service plan/promotion database; and
retrieving data from the service plan/promotion database in response to client queries relating to digital service plans and related promotions that are available for the client's geographic location.

9. The method of claim 8 wherein the service plan/promotion database comprises a provider table storing information on each service provider.

10. The method of claim 8 wherein the service plan/promotion database comprises a service plan table storing information on each digital service plan.

11. The method of claim 10 wherein the service plan/promotion database comprises a promotions table storing information on promotions for digital service plans.

12. The method of claim 8 further comprising maintaining a consistent hierarchical relationship between providers, digital service plans, and promotions in the service plan/promotion database.

13. The method of claim 8 further comprising displaying the retrieved data using a browser-based interface for clients.

14. A system for managing digital service plans and related promotions across a plurality of service providers comprising:
a service plan/promotion database having:
(a) a provider table storing information on each service provider;
(b) a service plan table storing information on each digital service plan offered by service providers; and
(c) a promotions table storing information on promotions for digital service plans;
a service provider interface receiving data from a plurality of service providers regarding digital service plans and related promotions that are available over a range of geographic locations, and incorporating said data into the service plan/promotion database; and
a client interface enabling a client to retrieve and display data from the service plan/promotion database relating to digital service plans and related promotions that are available for the client's geographic location.

15. The system of claim 14 further comprising a hierarchy manager maintaining a consistent hierarchical relationship between providers, digital service plans, and promotions.

16. The system of claim 14 wherein the service provider interface further provides validation and normalization of data received from service providers in a plurality of formats.
